(19) United States
(12) Patent Application Publication
(10) Pub. No.: US 2008/0094484 A1
(43) Pub. Date: Apr. 24, 2008

(54) Image capture methods and systems

(75) Inventor: Mu-Hsing Wu, Chiayi City (TW)

Correspondence Address: QUINTERO LAW OFFICE, PC, 2210 MAIN STREET, SUITE 200, SANTA MONICA, CA, 90405, US

(73) Assignees: QISDA CORPORATION, Taoyuan County (TW); BENQ CORPORATION, Taipei (TW)

(21) Appl. No.: 11/869,620

(22) Filed: Oct. 9, 2007

(30) Foreign Application Priority Data
Oct. 23, 2006 (TW) TW95139007

(51) Int. Cl. H04N 9/73

(52) U.S. Cl. 348/223.1; 348/E09.052

(57) ABSTRACT

Image capture methods and systems. First image data with an environmental light source is captured, and second image data with a pre-flash light source of a strobe is captured. During image capture, each pixel therein is respectively performed with a white balance adjustment according to the first and the second image data.

### BACKGROUND OF THE INVENTION

1. Field of the Invention

The invention relates generally to image capture methods and systems, and, more particularly, to methods and systems performing a white balance adjustment on respective pixels in images captured with two light sources comprising an environmental light source and a flash light source of a strobe.

2. Description of the Related Art

Digital cameras with image sensors such as charge coupled device (CCD) or complementary metal oxide semiconductor (CMOS) have gradually replaced conventional film cameras. Digital cameras have become commonplace, due to ease of review and processing of captured images in related devices such as computers.

Generally, digital cameras need an auxiliary exposure mechanism from a strobe for image capture in a darker environment. At the time, the captured images are simultaneously affected by an environmental light source and a flash light source of a strobe. Additionally, since the output capability of a strobe is limited, the effects of flash light source on different regions in a field may also be different. For example, some regions may mostly receive light from the flash light source, some regions may mostly receive light from the environmental light source, and some regions may receive light from both light sources in a specific proportion.

In conventional white balance adjustment mechanisms, digital cameras perform a gain adjustment on an entire image. For example, R and B channels are multiplied by a compensation gain value, respectively. Since conventional mechanisms cannot perform white balance adjustment on different regions in an image, and are unable to regulate two different light sources, color deviation can occur in local regions of the adjusted image if only one of the flash light source or the environmental light source is selected for adjustment. If the difference in color temperature of the flash light source and the environmental light source is significant, color deviation may be more serious.

### BRIEF SUMMARY OF THE INVENTION

Image capture methods and systems are provided.

In an embodiment of an image capture method, first image data with an environmental light source is captured. A strobe pre-flashes, and second image data with a pre-flash light source of the strobe and the environmental light source is captured. During image capture, each pixel in a captured image is respectively performed with a white balance adjustment according to the first and the second image data.

An embodiment of an image capture system comprises a strobe, an image sensor, a signal processor, and a strobe auto-white balance (AWB) unit. The signal processor captures first image data with an environmental light source via the image sensor. The signal processor drives the strobe to pre-flash, and captures second image data with a pre-flash light source of the strobe and the environmental light source via the image sensor. During image capture, the strobe AWB unit respectively performs a white balance adjustment on each pixel in a captured image according to the first and the second image data.

In an embodiment of an image capture method, first image data is captured with an environmental light source, and second image data is captured with a pre-flash light source of a strobe and the environmental light source. Third image data with the pure pre-flash light source is calculated according to the first and second image data. At least one first white balance gain of at least one image channel is calculated according to the first image data, and at least one second white balance gain of the image channel is calculated according to the third image data. Fourth image data with a pure main-flash light source is calculated according to the third image data and a main flash ratio. A first matrix and a second matrix are defined according to the first and fourth image data, where the first and second matrices respectively record at least one contribution ratio of the main flash and the environmental light source for each pixel in an image in a preview mode. At least one third matrix is defined according to the first and second white balance gains, and the first and second matrices, where the third matrix records at least one third white balance gain corresponding to the image channel for each pixel in an image in the preview mode. A fourth matrix is obtained using interpolation according to the third matrix, where the fourth matrix records at least one fourth white balance gain for each pixel in an image in a capture mode. During image capture, each pixel in a captured image is respectively performed with a white balance adjustment according to the fourth matrix.

Image capture methods and systems may take the form of program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an image capture system;

FIG. 2 is a schematic diagram illustrating image data of a Bayer pattern; and

FIG. 3 is a flowchart of an embodiment of an image capture method.

### DETAILED DESCRIPTION OF THE INVENTION

Image capture methods and systems are provided.

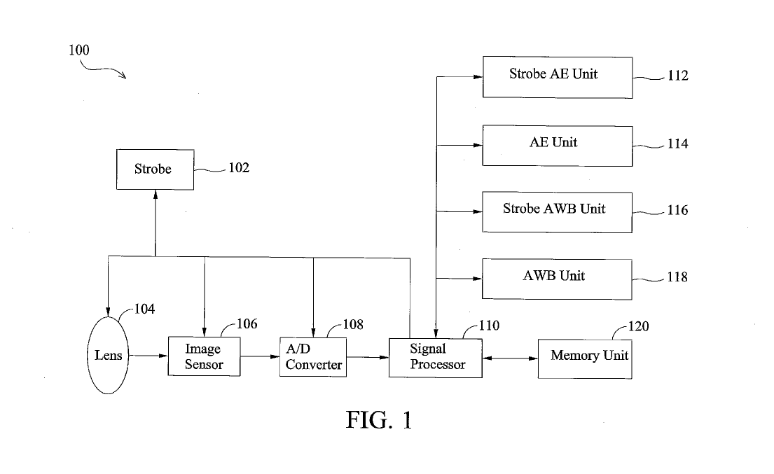

FIG. 1 illustrates an embodiment of an image capture system.

The image capture system 100 may be a digital camera, comprising a strobe 102, lens 104, an image sensor 106, an analog/digital (A/D) converter 108, a signal processor 110, a strobe auto-exposure (AE) unit 112, an AE unit 114, a strobe auto-white balance (AWB) unit 116, an AWB unit 118, and a memory unit 120.

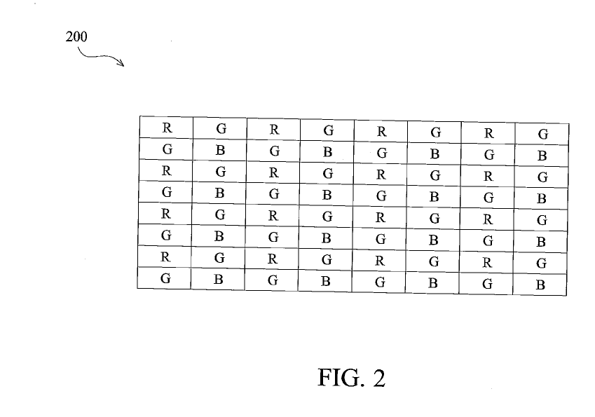

The signal processor 110 controls the diaphragm and shutter of the lens 104, the exposure time and data output mode of the image sensor 106, the magnification of the A/D converter 108 and the strength of the strobe 102 to capture original image data in a preview mode via the image sensor 106. The signal processor 110 stores related data in the memory unit 120. It is understood that the image sensor 106 may be a CCD (Charge Coupled Device) or CMOS (Complementary Metal Oxide Semiconductor), and the output modes thereof comprise a preview mode and a capture mode, where the original image data in the preview mode is a subset of that in the capture mode. This embodiment is suitable for use in image data of a Bayer pattern 200, as shown in FIG. 2, where R, G and B represent data in red, green and blue channels, respectively. It is noted that the image data is not limited to the Bayer pattern, any kind of image data can be applied to the application.

The AE unit 114 analyzes the original image data in the preview mode in the memory unit 120 to determine and return appropriate exposure parameters to the signal processor 110. The strobe AE unit 112 determines output strength of the strobe 102 for image capture according to two original image data in the preview mode. The first original image data is an image detected by the image sensor 106 without the flash light source of the strobe 102, and the second is an image detected by the image sensor 106 during a pre-flash of the strobe 102, where the signal processor 110 drives the strobe 102 to pre-flash. The AWB unit 118 analyzes the original image data in the preview mode in the memory unit 120 to determine appropriate white balance parameters according to the image data and a white balance algorithm. The strobe AWB unit 116 determines a white balance parameter such as white balance gain value for each pixel in an image during capture according to two original image data in the preview mode and the white balance algorithm. Similarly, a first original image data is an image detected by the image sensor 106 without the flash light source of the strobe 102, and the second is an image detected by the image sensor 106 during a pre-flash of the strobe 102, where the signal processor 110 drives the strobe 102 to pre-flash. After the white balance parameter for each pixel is determined, the signal processor 110 performs a white balance adjustment on respective pixels accordingly. It is understood that various white balance parameters can be calculated using white balance algorithms according to various requirements, and any white balance algorithm can be applied to the application.

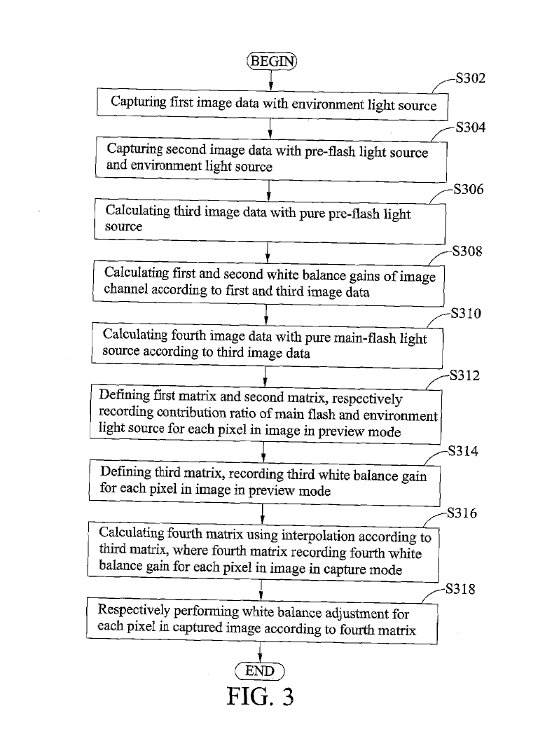

FIG. 3 shows an embodiment of an image capture method for use in a digital camera.

In step S302, the signal processor 110 captures first image data (PreviewBayerData_NoPreflash) with an environmental light source via the lens 104 and the image sensor 106. In step S304, the signal processor 110 drives the strobe 102 to pre-flash, and captures second image data (PreviewBayerData_Preflash) with a pre-flash light source of the strobe 102 and the environmental light source via the lens 104 and the image sensor 106. In step S306, the strobe AWB unit 116 subtracts the first image data from the second image data to obtain third image data (PreviewBayerData_PurePreflash) with the pure pre-flash light source.

In step S308, the AWB unit 118 calculates at least one first white balance gain (Rgain_NoFlash and Bgain_NoFlash) of at least one image channel such as R and B channels according to the first image data, and the AWB unit 118 calculates at least one second white balance gain (Rgain_PureFlash and Bgain_PureFlash) of the image channel according to the third image data. In step S310, the strobe AWB unit 116 calculates fourth image data (PreviewBayerData_PureMainflash) with a pure main-flash light source according to the third image data and a main flash ratio calculated by the strobe AE unit 112, where the main flash ratio is a ratio of output strength of the strobe 102 of the main flash to that of the pre-flash.

In step S312, the strobe AWB unit 116 defines a first matrix ([MainFlashContributiveFactor]) and a second matrix ([NoFlashContributiveFactor]) according to the first and fourth image data. The dimension of the first and second matrices is identical to that of the image data in the preview mode, and the first and second matrices respectively record at least one contribution ratio of the main flash and the environmental light source for each pixel in an image in the preview mode.

The first matrix ([MainFlashContributiveFactor]) and the second matrix ([NoFlashContributiveFactor]) are calculated as:

[MainFlashContributiveFactor]=PreviewBayerData_PureMainflash/(PreviewBayerData_PureMainflash+PreviewBayerData_NoPreflash); and

[NoFlashContributiveFactor]=PreviewBayerData_NoPreflash/(PreviewBayerData_PureMainflash+PreviewBayerData_NoPreflash).

In step S314, the strobe AWB unit 116 defines at least one third matrix ([RgainTable1] and [BgainTable1]) according to the first and second white balance gains, and the first and second matrices, where the third matrix records at least one third white balance gain corresponding to the image channel (R channel and B channel) for each pixel in an image in the preview mode. Similarly, the dimension of the third matrix is identical to that of the image data in the preview mode.

The at least one third matrix ([RgainTable1] and [BgainTable1]) is calculated as: [RgainTable1]=Rgain_NoFlash*[NoFlashContributiveFactor]+Rgain_PureFlash*[Mai nFlashContributiveFactor]; and

[BgainTable1]=Bgain_NoFlash*[NoFlashContributiveFactor]+Bgain_PureFlas h*[MainFlashContributiveFactor].

In step S316, the strobe AWB unit 116 calculates at least one fourth matrix ([RgainTable2] and [BgainTable2]) using interpolation such as Bilinear interpolation according to the third matrix, where the fourth matrix records at least one fourth white balance gain for each pixel in an image in the capture mode. The dimension of the fourth matrix is identical to that of the image data in the capture mode. During image capture, the signal processor 110 respectively performs a white balance adjustment on each pixel in the captured image according to the at least one fourth white balance gain in the fourth matrix calculated by the strobe AWB unit 116.

Image capture methods and systems, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those skilled in the technology can still make various alterations and modifications without departing from the scope and spirit of this invention. Therefore, the scope of the present invention shall be defined and protected by the following claims and their equivalents.

What is claimed is:

1. An image capture method for use in a digital camera having a strobe, comprising:
capturing first image data with an environmental light source;
driving the strobe to pre-flash, and capturing second image data with a pre-flash light source of the strobe and the environmental light source; and
during image capture, respectively performing a white balance adjustment on each pixel in a captured image according to the first and the second image data.

2. The method of claim 1 further comprising:
calculating third image data with the pure pre-flash light source according to the first and second image data;
calculating fourth image data with a pure main-flash light source according to the third image data and a main flash ratio.
calculating at least one first white balance gain of at least one image channel according to the first image data;
calculating at least one second white balance gain of the image channel according to the third image data; and
respectively performing the white balance adjustment on each pixel in the captured image according to the first and second white balance gains.

3. The method of claim 2 further comprising:
defining a first matrix and a second matrix according to the first and fourth image data, where the first and second matrices respectively record at least one contribution ratio of the main flash and the environmental light source for each pixel in an image in a preview mode;
defining at least one third matrix according to the first and second white balance gains, and the first and second matrices, where the third matrix records at least one third white balance gain corresponding to the image channel for each pixel in the image in the preview mode; and
respectively performing the white balance adjustment on each pixel in the captured image according to the third matrix.

4. The method of claim 3 further comprising:
calculating a fourth matrix using interpolation according to the third matrix, where the fourth matrix records at least one fourth white balance gain for each pixel in the image in the capture mode; and
respectively performing the white balance adjustment on each pixel in the captured image according to the fourth matrix.

5. The method of claim 4 further comprising calculating the fourth matrix using Bilinear Interpolation according to the third matrix.

6. The method of claim 2 wherein image channel comprises a R channel or a B channel.

7. An image capture system, comprising:
a strobe;
an image sensor; and
a signal processor capturing first image data with an environmental light source via the image sensor, driving the strobe to pre-flash, and capturing second image data with a pre-flash light source of the strobe and the environmental light source via the image sensor, and during image capture, respectively performing a white balance adjustment on each pixel in a captured image according to the first and the second image data.

8. The system of claim 7 further comprising a strobe auto-white balance (AWB) unit calculating third image data with the pure pre-flash light source according to the first and second image data, calculating fourth image data with a pure main-flash light source according to the third image data and a main flash ratio, calculating at least one first white balance gain of at least one image channel according to the first image data, calculating at least one second white balance gain of the image channel according to the third image data, and respectively performing the white balance adjustment on each pixel in the captured image according to the first and second white balance gains.

9. The system of claim 8 wherein the strobe AWB unit further defines a first matrix and a second matrix according to the first and fourth image data, where the first and second matrices respectively record at least one contribution ratio of the main flash and the environmental light source for each pixel in an image in a preview mode, defines at least one third matrix according to the first and second white balance gains, and the first and second matrices, where the third matrix records at least one third white balance gain corresponding to the image channel for each pixel in the image in the preview mode, and respectively performs the white balance adjustment on each pixel in the captured image according to the third matrix.

10. The system of claim 9 wherein the strobe AWB unit further calculates a fourth matrix using interpolation according to the third matrix, where the fourth matrix records at least one fourth white balance gain for each pixel in the image in the capture mode, and respectively performs the white balance adjustment on each pixel in the captured image according to the fourth matrix.

11. The system of claim 10 wherein the strobe AWB unit further calculates the fourth matrix using Bilinear Interpolation according to the third matrix.

12. The system of claim 8 wherein image channel comprises a R channel or a B channel.

13. An image capture method, comprising:
capturing first image data with an environmental light source;
capturing second image data with a pre-flash light source of a strobe and the environmental light source;
calculating third image data with the pure pre-flash light source according to the first and second image data;
calculating at least one first white balance gain of at least one image channel according to the first image data;
calculating at least one second white balance gain of the image channel according to the third image data;
calculating fourth image data with a pure main-flash light source according to the third image data and a main flash ratio;
defining a first matrix and a second matrix according to the first and fourth image data, where the first and second matrices respectively record at least one contribution ratio of the main flash and the environmental light source for each pixel in an image in a preview mode;
defining at least one third matrix according to the first and second white balance gains, and the first and second matrices, where the third matrix records at least one third white balance gain corresponding to the image channel for each pixel in the image in the preview mode;
calculating a fourth matrix using interpolation according to the third matrix, where the fourth matrix records at least one fourth white balance gain for each pixel in the image in the capture mode; and
during image capture, respectively performing the white balance adjustment on each pixel in a captured image according to the fourth matrix.

14. The method of claim 13 further comprising calculating the fourth matrix using Bilinear Interpolation according to the third matrix.

15. The method of claim 13 wherein image channel comprises a R channel or a B channel.

16. A machine-readable storage medium comprising a computer program, which, when executed, causes a device performing an image capture method, the method comprising:
capturing first image data with an environmental light source;
capturing second image data with a pre-flash light source of a strobe and the environmental light source;
calculating third image data with the pure pre-flash light source according to the first and second image data;
calculating at least one first white balance gain of at least one image channel according to the first image data;
calculating at least one second white balance gain of the image channel according to the third image data;
calculating fourth image data with a pure main-flash light source according to the third image data and a main flash ratio;
defining a first matrix and a second matrix according to the first and fourth image data, where the first and second matrices respectively record at least one contribution ratio of the main flash and the environmental light source for each pixel in an image in a preview mode;
defining at least one third matrix according to the first and second white balance gains, and the first and second matrices, where the third matrix records at least one third white balance gain corresponding to the image channel for each pixel in the image in the preview mode;
calculating a fourth matrix using interpolation according to the third matrix, where the fourth matrix records at least one fourth white balance gain for each pixel in the image in the capture mode; and
during image capture, respectively performing the white balance adjustment on each pixel in a captured image according to the fourth matrix.
